(19) United States
(12) Patent Application Publication
(10) Pub. No.: US 2008/0093906 A1
(43) Pub. Date: Apr. 24, 2008

(54) Method of Manufacturing a Motor Vehicle Seat, and a Seat Manufactured by Implementing the Method

(75) Inventor: Claude Gruson, Caligny (FR)

Correspondence Address: MILLER, MATTHIAS & HULL, ONE NORTH FRANKLIN STREET, SUITE 2350, CHICAGO, IL, 60606, US

(73) Assignee: Faurecia Sieges d'Automobile, Nanterre (FR)

(21) Appl. No.: 11/933,549

(22) Filed: Nov. 1, 2007

(30) Foreign Application Priority Data
Nov. 3, 2006 (FR) FR 06 09630
Apr. 22, 2005 (FR) 05 04094

(51) Int. Cl. B60N 2/20; B21J 15/02; B23P 11/00

(52) U.S. Cl. 297/361.1; 29/525.05

(57) ABSTRACT

A manufacturing method for manufacturing a motor vehicle seat, which method comprises: (a) providing an adjustment mechanism of a first side and an adjustment mechanism of a second side, each of which is provided with a control member and with a locking mechanism; (b) coupling the two control members together by a rigid link member; fastening the link member to the control member of the adjustment mechanism of the first side, and coupling the link member to the control member of the adjustment mechanism of the second side; inserting one into the other the link member and the control member of the adjustment mechanism of the second side; and applying radial deformation thereto.

### FIELD OF DISCLOSURE

The present invention relates to methods of manufacturing motor vehicle seats and to seats manufactured by implementing the methods.

### BACKGROUND OF THE DISCLOSURE

A motor vehicle seat conventionally includes a seat back whose inclination relative to the seat proper is adjustable via a hinge or mechanism for adjusting inclination about an axis of inclination. Conventionally, there exist two main categories of such hinge mechanisms. Firstly, there exist “continuous” hinge mechanisms, based on epicyclic gear trains, and in which the seat back can be locked relative to the seat proper in any relative angular position. In such continuous mechanisms, the seat proper and the seat back are continuously mechanically constrained to move together in rotation about the axis of inclination via the epicyclic gear train Secondly, “discontinuous” mechanisms are known that are, for example, based on locking slugs that are mounted to move radially relative to a toothed ring, and in which a large number of discrete locking positions are obtained, depending on the pitch of the teeth in the ring. With such discontinuous mechanisms, while they are in their unlocked state, the seat back is completely unconstrained relative to the seat proper about the axis of inclination. Usually, the seat back and the seat proper nevertheless remain constrained to move with each other in some other degree of freedom, e.g. in translation, even when the discontinuous mechanism is in the unlocked state.

### SUMMARY OF THE DISCLOSURE

The invention relates to methods of manufacturing such seats having discontinuous mechanisms. When two such mechanisms are disposed on either side of the seat, a link member must be used in order to enable them to be unlocked simultaneously by a single control lever actuated by the user. In order to obtain a good degree of locking, it is important, when manufacturing the seat, for the mechanisms to be coupled together while they are both in a fully locked state, i.e. without imparting any offset between them along the degree of freedom in question while they are being linked together.

The invention also relates to mechanisms for adjusting in particular a motor vehicle seat back not only by inclination but also by tipping or the like.

More particularly, the invention relates to a manufacturing method for manufacturing a motor vehicle seat having a first side and a second side that are spaced apart in a transverse direction, which method comprises:

(a) providing a first element and a second element that are coupled together on each side by respective adjustment mechanisms;

on each side, the respective adjustment mechanism comprising a moving part secured to the first element, a fixed part secured to the second element, a control member, and a locking mechanism controlled by the control member and adapted to be alternately in an inactive state in which the adjustment mechanism is unlocked, leaving the two parts completely unconstrained relative to each other in one adjustment degree of freedom so as to allow the two parts to move relative to each other for adjustment purposes, and in an active state in which the adjustment mechanism is locked so as to prevent the two parts from moving relative to each other for adjustment purposes; and

(b) coupling the two control members together via a rigid link member extending substantially in the transverse direction;

by fastening the link member to the control member of the adjustment mechanism of the first side, and by coupling the link member to the control member of the adjustment mechanism of the second side.

Document FR 2 882 707 describes an example of such a method of linking together two hinges that is generally satisfactory for reasons of compactness, of logistics, and of tooling, attempts are still being made to simplify the operations that are necessary once the seat is assembled. In particular, attempts are being made to eliminate the need for welding or crimping on the assembled seat.

To this end, according to the invention, the manufacturing method of the type in question further comprises the following steps:

in step (b), the link member and the control member of the adjustment mechanism of the second side are inserted one into the other with radial clearance normal to said transverse direction; then

the link member and the control member of the adjustment mechanism of the second side are fastened together by radial deformation so as to bring the link member into tight-fitting contact with the control member of the adjustment mechanism of the second side.

By means of these features, it is guaranteed that the two mechanisms are linked together by simple operations, while also guaranteeing that, once coupled together, the two mechanisms are in a fully locked (fully synchronized) state.

In preferred implementations of the invention, it is optionally possible to use one or more of the following features:

the link member is inserted into a through opening in the control member of the adjustment mechanism of the second side, and the link member is deformed radially by being enlarged;

the link member is provided with an open tubular end, and an enlarger member is forced into said tubular end;

said open tubular end is enlarged by inserting said enlarger member by force therein so as to impart compression stress to said tubular end in the link member;

said open tubular end is enlarged by removing said enlarger member by force in order to impart traction stress to said end in the link member;

during step (a), the moving parts and the first element are provided in the form of an integral part;

during step (a), each locking mechanism is provided with a first locking member carried by the fixed part and having a first toothed portion, and with a second locking member carried by the moving part and having a second toothed portion that is complementary to the first toothed portion and that co-operates therewith in said active state, and the control member and the second locking member are provided in the form of an integral part;

during the step (a), each locking mechanism is provided with a first locking member carried by the fixed part and having a first toothed portion, and with a second locking member secured to the moving part and having a second toothed portion that is complementary to the first toothed portion and that co-operates therewith in the active state, and the control member is provided that is adapted to move the first locking member by contact between the control member and the first locking member;

the link member is provided with a first fastening portion and with a second fastening portion, the control member of the adjustment mechanism of each side is provided with a fastening portion, the second fastening portion of the link member is inserted through a through opening in the control member of the adjustment mechanism of the first side, and the link member is caused to slide in said opening until the second fastening portion of the link member and the fastening portion of the control member of the adjustment mechanism of the second side are inserted one into the other; and

an actuating lever is fastened to the link member beside the adjustment mechanism of the first side, it being possible for the actuator lever to be actuated by a user in order to place the adjustment mechanism of the first side in the inactive state

In another aspect, the invention provides a motor vehicle seat. Document FR 2 882 707 describes an example of such a seat that has a first side and a second side spaced apart in a transverse direction, and that comprises:

a first element and a second element that are coupled together on each side by respective adjustment mechanisms;

on each side, the respective adjustment mechanism comprising a moving part secured to the first element, a fixed part secured to the second element, a control member, and a locking mechanism controlled by the control member and adapted to be alternately in an inactive state in which the adjustment mechanism is unlocked, leaving the two parts completely unconstrained relative to each other in one adjustment degree of freedom so as to allow the two parts to move relative to each other for adjustment purposes, and in an active state in which the adjustment mechanism is locked so as to prevent the two parts from moving relative to each other for adjustment purposes; and

a rigid link member extending substantially in the transverse direction and coupling together the two control members, the link member being fastened to the control member of the adjustment mechanism of the first side and being coupled to the control member of the adjustment mechanism of the second side.

According to the invention, and in order to achieve the above-mentioned object, the seat has the following characteristics:

the link member and the control member of the adjustment mechanism of the second side are inserted one into the other with radial clearance normal to said transverse direction;

the seat further comprises a deformation element adapted to deform radially at least one member chosen from the link member and the control member of the adjustment mechanism of the second side so as to bring them into tight-fitting contact with each other.

In a particular embodiment, it is possible also to use one or more of the following features:

the link member comprises a first fastening portion and a second fastening portion, and the control member of the adjustment mechanism of each side is provided with a fastening portion;

the fastening portion of the control member of the adjustment mechanism of the second side defines a through opening, and the link member comprises a hollow cylindrical tube of circular section, at least a portion of which forms the second fastening portion, inserted into said through opening;

the first fastening portion of the link member has a cross-section that is not rotationally symmetrical, and the fastening portion of the control member of the adjustment mechanism of the first side has a shape complementary to the shape of said cross-section of the first fastening portion of the link member, the seat further comprising an actuator lever that can be actuated by a user for placing the adjustment mechanism of the first side in the inactive state, the actuator lever being coupled to the link member;

the seat further comprises a seat back framework defining the first element, a base defining the second element, the adjustment mechanisms being constituted by discontinuous hinges adapted to adjusting the relative inclination of the seat back framework and of the base, and each comprising a respective first cheek plate and second cheek plate, the first cheek plates and the second cheek plates respectively forming the first parts and the second parts;

the seat further comprises a base and a seat back framework provided with two cheek plates, the base forming the second element, the seat back framework forming the first element and the cheek plates forming the moving parts, the locking mechanisms being adapted to be in their active state when the fixed parts and the moving parts are in a single relative position only.

### BRIEF DESCRIPTION OF THE DRAWINGS

Other characteristics and advantages of the invention appear on reading the following description of various embodiments, given by way of non-limiting example, and with reference to the accompanying drawings.

In the drawings:

FIG. 1 is a diagrammatic view of a vehicle seat of the invention;

FIG. 2 is an axial section view showing adjustment mechanisms that couple the seat back to the seat proper in the seat of FIG. 1, in a first step of the manufacturing method;

FIG. 3 is a cutaway view of the adjustment mechanism of the first side shown in FIG. 2, seen looking along the arrow referenced A in FIG. 2;

FIGS. 4a and 4b are diagrammatic fragmentary section views of the portion referenced IV in FIG. 2, showing the adjustment mechanism of the second side, and showing a second step of a first implementation of the manufacturing method;

FIGS. 5a and 5b are views corresponding respectively to FIGS. 4a and 4b, for a second implementation of the manufacturing method;

FIG. 6 is a rear view showing a variant application of the invention to a seat;

FIG. 7 is a perspective view showing the adjustment mechanisms;

FIG. 8 is a side view showing the adjustment mechanism of the second side in a first position; and

FIG. 9 is a side view showing the adjustment mechanism of the second side in a second position.

In the various figures, like references are used for elements that are identical or similar.

### DETAILED DESCRIPTION OF THE DISCLOSURE

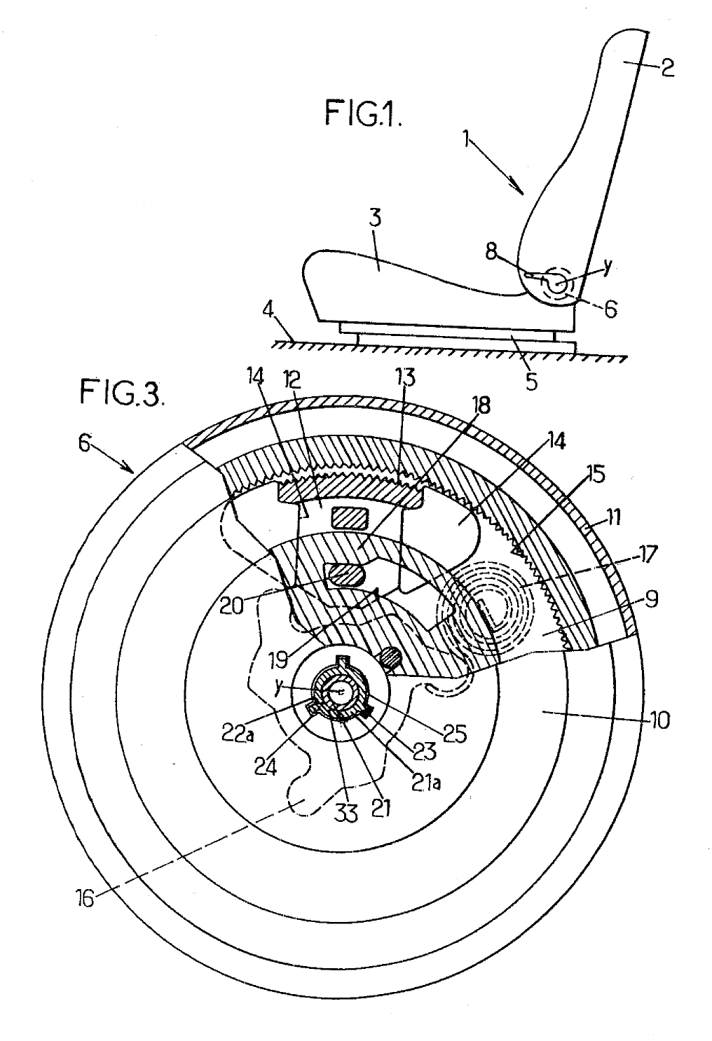

FIG. 1 shows a motor vehicle seat 1 having a seat back 2 that is mounted to pivot on a seat proper 3 about a transverse horizontal pivot axis Y, the seat proper 3 being mounted on the floor 4 of the vehicle, e.g. via runners 5

Alternatively, the seat back could be mounted to move in rotation on a base element other than the seat proper 3, such as directly on the runners 5 or on the floor 4.

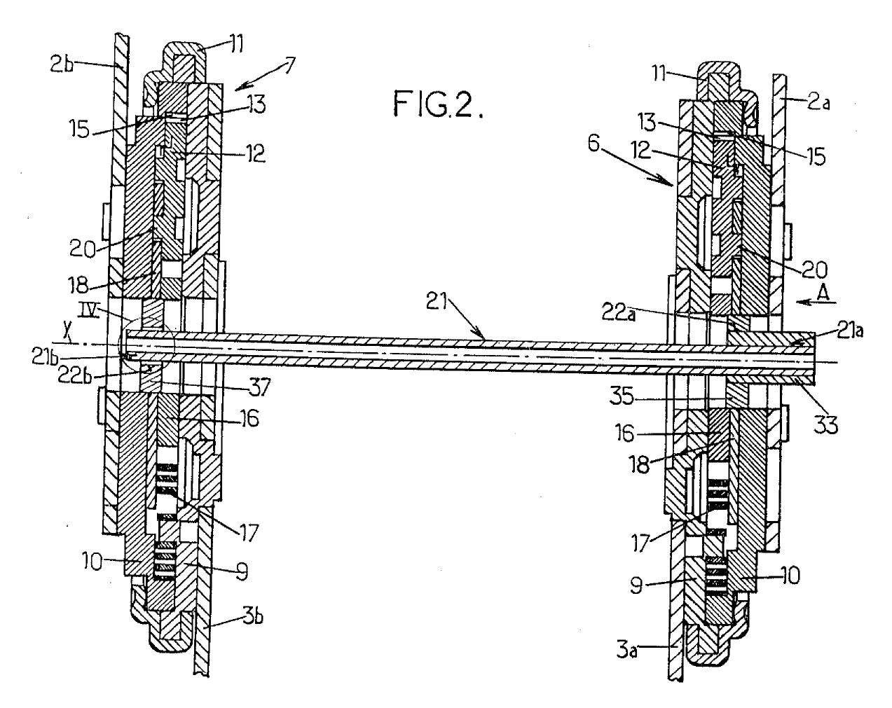

The seat back 2 is caused to pivot by first and second hinge mechanisms 6, 7 (see FIGS. 1 and 2) constituting adjustment mechanisms that are disposed respectively on first and second sides of the seat, and that can be actuated in synchronized manner by a handle 8 or by some other actuator member.

As shown in FIGS. 2 and 3, the hinge mechanisms 6, 7 are disposed facing respective ones of side arms 2a, 2b that are disposed on either side of the framework of the seat, and that are thus spaced apart in a transverse direction of the seat. Each of these hinge mechanisms can include first and second parts in the form of first and second cheek plates 9 and 10, respectively referred to as the “fixed” cheek plate and as the “moving” cheek plate, and fastened respectively to the framework 3a, 3b of the seat proper and to the framework 2a, 2b of the seat back. These two hinge mechanisms can, for example, be adapted normally to prevent the seat back 2 from pivoting relative to the seat propel 3 in a plurality of discrete locking positions, and to unlock when action is taken on the handle 8, as described, for example, in Document FR-A-2 740 406 Locking is impossible between two consecutive locking positions. When the hinge mechanism is in the unlocked state, the seat back is free to turn relative to the seat proper about the pivot axis.

More particularly, in this example, the two cheek plates 9, 10 of the two hinge mechanisms can be substantially circular in shape and be coupled together by a crimped metal outer ring 11, thus each defining an internal housing that contains a locking mechanism comprising one or more slugs 12, each of which is provided with an outside set of teeth 13

Each slug 12 is mounted to move radially in guides 14 that belong to the first cheek plate 9, between an active state in which the set of teeth 13 of the slug comes to mesh with an inside set of teeth 15 belonging to the second cheek plate 10, and an inactive state (FIG. 3) in which the slug 12 is moved radially inwards in a manner such that its set of teeth 13 does not cooperate with the inside set of teeth 15 of the second cheek plate 10.

The slug 12 is caused to move between its active state and its inactive state by a control member such as a cam 16 that is mounted to pivot about the axis Y. This cam 16 is urged resiliently by one or more springs 17 towards a locking position in which it moves the slug 12 radially outwards into its active state, and said cam 16 can be moved in rotation by actuating the handle 8 into an unlocking position (FIG. 3) in which said cam enables the slug 12 to move radially inwards into its inactive state.

The slug 12 can optionally be forced to move radially inwards by a control plate 18 provided with a through slot 19 in which a lug 20 belonging to the slug 12 is engaged, the outside edge of the slot 19 co-operating with the lug to move the slug 12 radially inwards when the cam 16 is in the unlocking position.

In order to be controlled in synchronized manner by the handle 8, the cams 16 of the hinge mechanisms of the first and second sides 6, 7 are coupled together by a link member such as a tubular rigid link bar 21 extending substantially in the transverse direction. For example, said bar is made of steel, of aluminum, or of a composite material.

As can be seen in particular in FIG. 2, during a first step of manufacture of the seat, the link bar 21 is inserted so that, on the first side, a sleeve 33 that is an integral part of the link bar 21 is inserted into a ring 35 that is an integral part of the control member 16 of the hinge mechanism of the first side 6 and that defines a fastening portion 22a The sleeve 33 of the link bar 21 defines a first fastening portion 21a that is complementary to the fastening portion 22a of the ring 35. The first fastening portion 21a of the link bar is constituted by a first fastening part in relief situated, for example, substantially at a first end of the link bar. The fastening portion 22a of the ring 35 is constituted by a fastening pattern formed by a through opening 22a that is complementary to the first fastening part in relief.

On the second side, the link bar 21 has a second fastening portion 21b. A ring 37 that is an integral part of the control member 16 of the hinge mechanism of the second side 7 defines a fastening portion 22b that is complementary to the second fastening portion 21b of the link bar 21. The second fastening portion of the link bar 21 is constituted by a second fastening part in relief 21b situated, for example, at a second end of the link bar. The fastening portion of the ring 37 is constituted by a fastening pattern 22b formed by a though opening 22b. The second fastening part in relief 21b is inserted into the fastening pattern 22b of the hinge mechanism of the second side 7. As shown in FIG. 3, in one embodiment, the inside profile of the opening 22a in the hinge mechanism of the first side 6 can be formed non-axisymmetrically, and in particular it can be of shape complementary to the section of the sleeve 33 that is an integral part of the link bar at the first end 21a of the link bar so that said opening and said sleeve can be mutually engaged rigidly by means of their complementary shapes. In the embodiment that is shown merely by way of illustration, the sleeve 33 is provided with three ribs 23 inserted into matching grooves 24 in the opening 22a of the ring 35. Outside of the ribs, the profile of the opening 22a can have a toothed portion 25.

As shown in FIG. 2, once the link bar is inserted in the corresponding opening 22b in the hinge mechanism on the second side, the second end 21b of said link bar has a narrow circular section so that, after such insertion, the second end 21b is not held mechanically in the second opening 22b, but rather it is engaged with a certain amount of clearance therein.

During the next step of the manufacturing method, a radial deformation such as an enlargement of the end 21b of the link bar can be implemented in order to bring said end of the link bar into tight-fitting contact with the ring 37 that is an integral part of the control member formed by the cam 16 of the hinge mechanism of the second side.

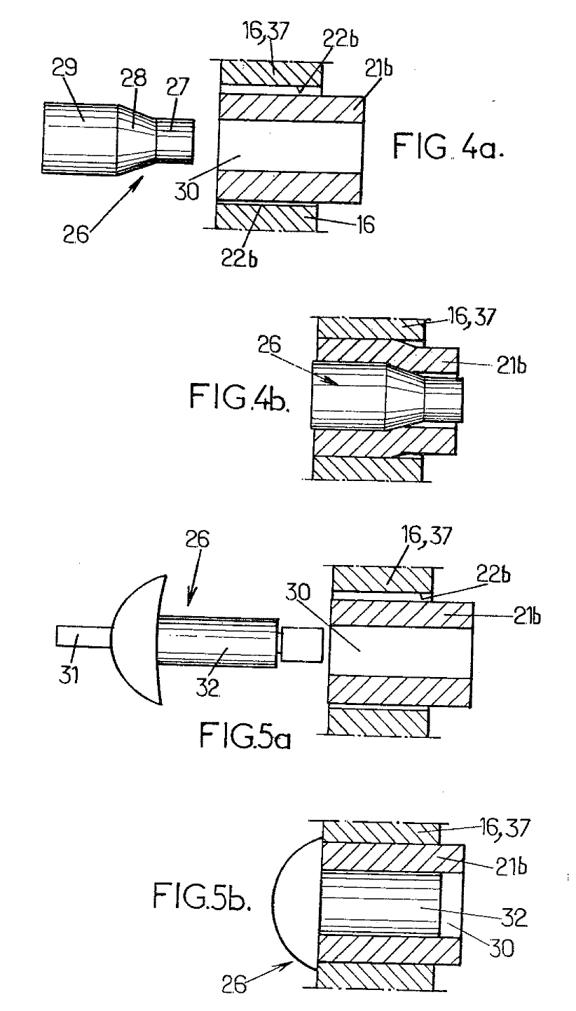

A first non-limiting embodiment is shown diagrammatically in FIGS. 4a and 4b In this example, at its second end 21b, the link bar 21 has an annular cross-section that has an outside diameter of 10 mm and an inside diameter of 8 mm. Therefore, clearance exists between the outside face of the link bar and the toothed inside face of the ring 37 that is an integral part of the cam 16 which has an inside diameter lying in the range 10.1 mm to 10.5 mm. An enlarger element 26 is shown in the form of a stud having a guide portion 27 of circular section and of diameter that is approximately 7.8 mm, an intermediate portion 28 flaring from the guide portion 27 to an enlarger portion 29 that is 85 mm in diameter. The stud has a length of about 22 mm, and the measurable angle, in section, between the guide portion and the intermediate portion is about 175°

As shown in FIG. 4b, the stud 26 is inserted by force by means of a suitable tool into the open tubular end 30 of the link bar. The link bar is, if necessary, retained during this insertion. This operation results in compression stress and in radial deformation orthogonal to the transverse axis of the seat, namely enlargement of the second end 21b of the link bar, bringing said second end into tight-fitting contact with the ring 37 that is an integral part of the cam 16 forming the control member for controlling the hinge mechanism of the second side. Thus, the two hinge mechanisms are coupled together by the link bar 21 while both being in a fully locked state.

In a variant embodiment shown in FIGS. 5a and 5b, it is possible to use an expandable rivet or “pop” rivet for the enlarger element 26, such a rivet being known conventionally to the person skilled in the art. Removing the rod 31 results in radial deformation and in traction stress on the body 32 of the rivet, and in enlargement thereof so as to bring the second fastening part in relief 21b of the link member into tight-fitting contact with the fastening pattern 22b formed by the through opening in the cam 16 of the hinge mechanism of the second side. It is also proposed to perform this enlargement step in numerous variants of the two embodiments presented respectively in FIGS. 4a and 4b, and in FIGS. 5a and 5b

The link bar 21, e.g. at its first end 21a, can be coupled to the handle 8, forming an actuator lever that can be actuated by an occupant of the seat in order to unlock the locking mechanisms of the hinge mechanisms of the seat simultaneously. This linking to the handle can alternatively take place before or after the enlargement step.

Once it has been enlarged, the second end 21b of the link member 21 is in tight-fitting engagement with the ring 37 that is an integral part of the cam 16, optionally via sets of teeth provided on the periphery of the opening 22b. Although FIGS. 2 to 5b show that the opening 22b in the control member for controlling the hinge mechanism of the second side is fully circular, it should be noted that, in a particularly practical manner, it is possible to use identical parts for the cams 16 of the locking mechanisms of the first and second sides, it being understood that the grooves 24 are inoperative at the hinge mechanism of the second side 7.

In the embodiment shown, the tubular portion of the link bar 21 is inserted entirely through the opening 22a provided in the cam 16 of the hinge mechanism of the first side 6. However, the invention is not limited to this particular insertion implementation, and it is possible to make provision for the link member 21 and the control member 16 of the hinge mechanism of the second side to be inserted in some other manner one into the other.

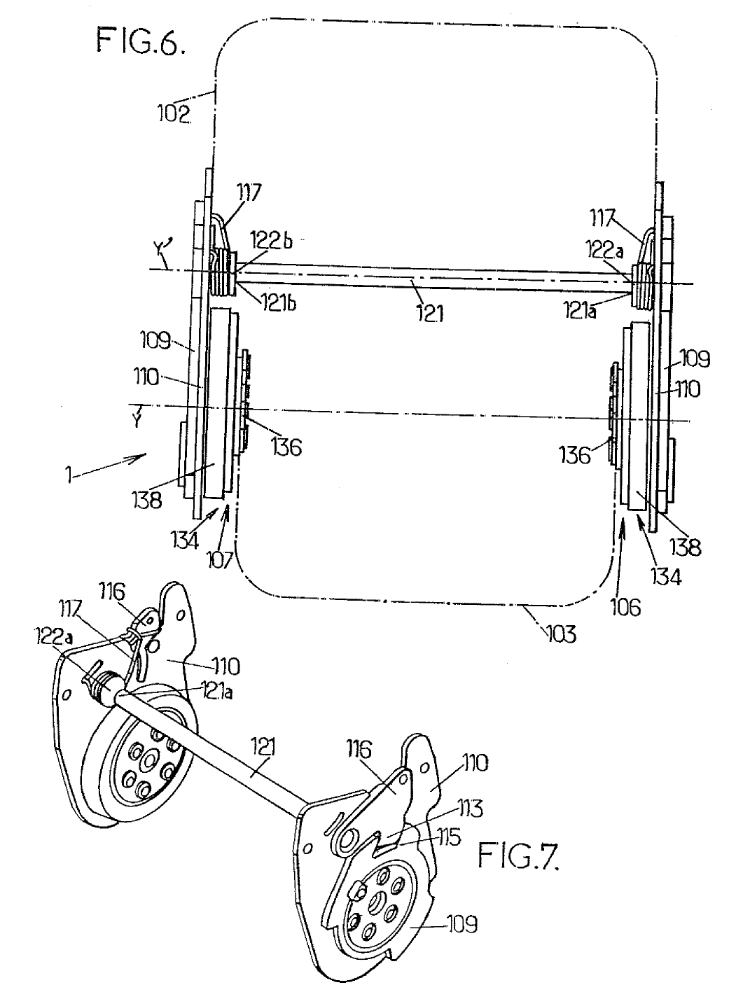

FIG. 6 shows a valiant embodiment of the invention and shows a seat 101 having a seat back 102 mounted to pivot on a seat proper 103 about a transverse horizontal pivot axis Y. The elements shown in FIGS. 6 to 9 that correspond to the elements shown in FIGS. 1 to 3 have like references plus 100.

The seat back 102 is caused to pivot by first and second hinge mechanisms 134 that are similar to the hinge mechanisms 6, 7 that are described above, said first and second hinge mechanisms being disposed on either side of the seat. The seat back 102 can also be tipped forwards relative to the seat proper 103, by means of a first tipping mechanism 106 and by means of a second tipping mechanism 107, which mechanisms constitute adjustment mechanisms that are disposed on respective ones of first and second sides of the seat and that can be actuated in synchronized manner by an actuator member (not shown).

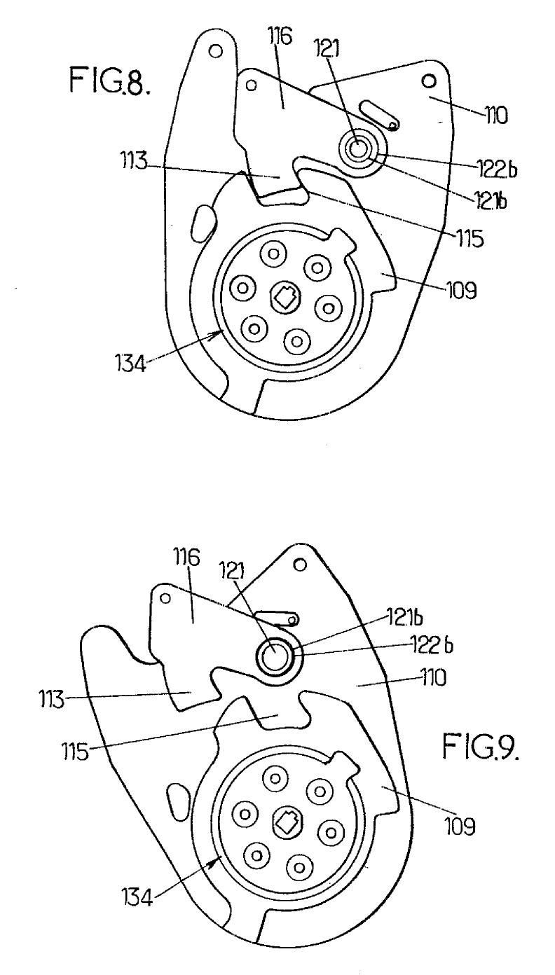

Each of these tipping mechanisms 106, 107 comprises a first cheek plate 109 that is secured to the moving cheek plate of the corresponding hinge mechanism 134, a second cheek plate 110 secured to the seat back 102, and a catch 116 mounted to pivot about a transverse axis Y′, parallel to the pivot axis Y, on the second cheek plate 110 between an active position shown in FIG. 8 and an inactive position shown in FIG. 9. The catch 116 is provided with a tooth 113 that co-operates with a notch 115 into which the tooth is inserted when the catch 116 is in the active position, in order to prevent the second cheek plate 110 from moving in rotation relative to the first cheek plate 109 about the axis of inclination Y of the seat 1. When the catch is in the inactive position, the tooth 113 of the catch is spaced apart from the notch 115 in the first cheek plate, thereby allowing the second cheek plate 110 to move in rotation relative to the first cheek plate 109 about the axis of inclination Y of the seat 1, as shown in FIG. 9. A spiral spring 117 urges the catch to return to the active position.

In order to enable the catches 116 of the tipping mechanisms of the first and second sides 106, 107 to be controlled in synchronized manner, said catches are coupled together by a link member such as a tubular rigid link bar 121 extending substantially along the transverse axis Y′, which link bar is similar to the above-described link bar 21 The actuator lever makes it possible to act on said link bar 121.

As indicated above for the link bar 21, during a first step of manufacture of the seat, the link bar 121 is inserted so that a first fastening part in relief 121a, situated at a first end of the link bar, is inserted into a complementary fastening pattern 122a in the catch 116 of the tipping mechanism of the first side 6, which pattern is implemented in the form of a through opening 122a. A second fastening part in relief 121b situated at the opposite end of the link bar 121 is inserted in a complementary fastening pattern 122b, such as the through opening 122b, in the catch 116 in the tipping mechanism of the second side 107.

The characteristics of the link bar 121 and of how it is fastened to the catch 116 of the tipping mechanism of the second side 107 are similar to the characteristics of the link bar 21 and of how it is fastened to the control cam 16. They are not therefore described in any more detail.

What is claimed is:

1. A manufacturing method for manufacturing a motor vehicle seat having a first side and a second side that are spaced apart in a transverse direction, which method comprises:
(a) providing a first element and a second element that are coupled together on each side by respective adjustment mechanisms;
on each side, the respective adjustment mechanism comprising a moving part secured to the first element, a fixed part secured to the second element, a control member, and a locking mechanism controlled by the control member and adapted to be alternately in an inactive state in which the adjustment mechanism is unlocked, leaving the two parts completely unconstrained relative to each other in one adjustment degree of freedom so as to allow the two parts to move relative to each other for adjustment purposes, and in an active state in which the adjustment mechanism is locked so as to prevent the two parts from moving relative to each other for adjustment purposes; and
(b) coupling the two control members together via a rigid link member extending substantially in the transverse direction;
by fastening the link member to the control member of the adjustment mechanism of the first side, and by coupling the link member to the control member of the adjustment mechanism of the second side;
wherein, in step b), the link member and the control member of the adjustment mechanism of the second side are inserted one into the other with radial clearance normal to said transverse direction, then the link member and the control member of the adjustment mechanism of the second side are fastened together by radial deformation so as to bring the link member into tight-fitting contact with the control member of the adjustment mechanism of the second side.

2. A manufacturing method according to claim 1, in which the link member is inserted into a through opening in the control member of the adjustment mechanism of the second side, and in which the link member is deformed radially by being enlarged.

3. A manufacturing method according to claim 2, in which the link member is provided with an open tubular end, and an enlarger member is forced into said tubular end.

4. A manufacturing method according to claim 3, in which said open tubular end is enlarged by inserting said enlarger member by force therein so as to impart compression stress to said tubular end in the link member.

5. A manufacturing method according to claim 3, in which said open tubular end is enlarged by removing said enlarger member by force in order to impart traction stress to said end in the link member.

6. A manufacturing method according to claim 1, in which, during step a), the moving parts and the first element are provided in the form of an integral part.

7. A manufacturing method according to claim 1, in which, during step a), each locking mechanism is provided with a first locking member carried by the fixed part and having a first toothed portion, and with a second locking member carried by the moving part and having a second toothed portion that is complementary to the first toothed portion and that co-operates therewith in said active state;
and in which the control member and the second locking member are provided in the form of an integral part.

8. A manufacturing method according to claim 1, in which, during the step a), each locking mechanism is provided with a first locking member carried by the fixed part and having a first toothed portion, and with a second locking member secured to the moving part and having a second toothed portion that is complementary to the first toothed portion and that co-operates therewith in the active state;
and in which the control member is provided that is adapted to move the first locking member by contact between the control member and the first locking member.

9. A manufacturing method according to claim 1, in which the link member is provided with a first fastening portion and with a second fastening portion, the control member of the adjustment mechanism of each side is provided with a fastening portion, the second fastening portion of the link member is inserted through a through opening in the control member of the adjustment mechanism of the first side, and the link member is caused to slide in said opening until the second fastening portion of the link member and the fastening portion of the control member of the adjustment mechanism of the second side are inserted one into the other.

10. A manufacturing method according to claim 1, in which an actuating lever is fastened to the link member beside the adjustment mechanism of the first side, it being possible for the actuator lever to be actuated by a user in order to place the adjustment mechanism of the first side in the inactive state.

11. A motor vehicle seat having a first side and a second side that are spaced apart in a transverse direction, and comprising:
a first element and a second element that are coupled together on each side by respective adjustment mechanisms;
on each side, the respective adjustment mechanism comprising a moving part secured to the first element, a fixed part secured to the second element, a control member, and a locking mechanism controlled by the control member and adapted to be alternately in an inactive state in which the adjustment mechanism is unlocked, leaving the two parts completely unconstrained relative to each other in one adjustment degree of freedom so as to allow the two parts to move relative to each other for adjustment purposes, and in an active state in which the adjustment mechanism is locked so as to prevent the two parts from moving relative to each other for adjustment purposes; and
a rigid link member extending substantially in the transverse direction and coupling together the two control members, the link member being fastened to the control member of the adjustment mechanism of the first side and being coupled to the control member of the adjustment mechanism of the second side;
wherein the link member and the control member of the adjustment mechanism of the second side are inserted one in the other with radial clearance normal to said transverse direction;
and wherein the seat further comprises a deformation element adapted to deform radially at least one member chosen from the link member and the control member of the adjustment mechanism of the second side so as to bring them into tight-fitting contact with each other.

12. A motor vehicle seat according to claim 11, in which the link member comprises a first fastening portion and a second fastening portion, and the control member of the adjustment mechanism of each side is provided with a fastening portion;
in which seat the fastening portion of the control member of the adjustment mechanism of the second side defines a through opening, and the link member comprises a hollow cylindrical tube of circular section, at least a portion of which forms the second fastening portion, inserted into said through opening;
in which seat the first fastening portion of the link member has a cross-section that is not rotationally symmetrical, and in which seat the fastening portion of the control member of the adjustment mechanism of the first side has a shape complementary to the shape of said cross-section of the first fastening portion of the link member, the seat further comprising an actuator lever that can be actuated by a user for placing the adjustment mechanism of the first side in the inactive state, the actuator lever being coupled to the link member.

13. A vehicle seat according to claim 11, further comprising a seat back framework defining the first element, a base defining the second element, the adjustment mechanisms being constituted by discontinuous hinges adapted to adjusting the relative inclination of the seat back framework and of the base, and each comprising a respective first cheek plate and second cheek plate, the first cheek plates and the second cheek plates respectively forming the first parts and the second parts.

14. A vehicle seat according to claim 11, further comprising a base and a seat back framework provided with two cheek plates, the base forming the second element, the seat back framework forming the first element and the cheek plates forming the moving parts, the locking mechanisms being adapted to be in their active state when the fixed parts and the moving parts are in a single relative position only.
